(19) United States
(12) Patent Application Publication
(10) Pub. No.: US 2005/0136746 A1
(43) Pub. Date: Jun. 23, 2005

(54) Replaceable multiple-functional interface card

(76) Inventor: Chii-Moon Liou, Taipei Hsien (TW)

Correspondence Address: Chii-Moon Liou, 235 Chung-Ho, P.O. Box 10-69, Taipei, TW

(21) Appl. No.: 10/740,038

(22) Filed: Dec. 19, 2003

(51) Int. Cl. H01R 24/04

(52) U.S. Cl. 439/668

(57) ABSTRACT

A replaceable multiple-functional interface card for inserting into an inserting seat is disclosed. The inserting seat has a rotary seat; and one side of the rotary set is installed with an inserting hole. The replaceable multiple-functional interface card comprises an interface card; a receptacle extended from one end of an interface card; a plug extended from one side of the receptacle; the plug being wound by three insulating wires; the three insulating wires dividing the plug into four surfaces. When the plug is inserted into the inserting hole, data in the interface card is transferred to or received from the inserting seat through the four surfaces. The plug is replaceable so as to replace interface card. The inserting seat is the inserting seat of a GPA satellite signal receiver or a blue tooth device, or a digital camera.

### FIELD OF THE INVENTION

The present invention relates to devices for transmitting data through interface cards, and particular to a replaceable multiple-functional interface card.

### BACKGROUND OF THE INVENTION

In the prior art, devices, such as GPS (global positioning satellite) receivers, blue tooth devices, digital cameras, etc., are confined to be connected to an interface card with the same specification. In another prior art for improving the above said defect, the device is installed with a plurality of inserting slots each for receiving a respective interface card so as to form a one to one mapping. The general used interface cards include USB interface cards (Universal Serial Bus interface card), SD interface cards (Secure Digital interface card), MS interface cards (Memory Stick interface card); CF interface cards (compact flash interface cards); MD interface cards (IBM Micro Drive interface card); SM interface cards (Smart Media interface card); MMC interface cards (Multi Media Card), etc. Or these interface cards are connected to the device by using an adaptor having a memory card reader interface, or a USB interface, or an IEEE 1394 interface through a transmission line to a computer mainframe. This is known in the prior art. Thereby, some of these prior arts emphasize the combination of the interface and the adaptor. In one prior art, a PCMCIA network card is extended with a microwave antenna, however, this has no relation to the content of the present invention which will be described in the following.

### SUMMARY OF THE INVENTION

Accordingly, the primary object of the present invention is to provide a replaceable multiple-functional interface card for inserting into an inserting seat. The inserting seat has a rotary seat; and one side of the rotary set is installed with an inserting hole. The replaceable multiple-functional interface card comprises an interface card; a receptacle extended from one end of an interface card; a plug extended from one side of the receptacle; plug being wound by three insulating wires; the three insulating wires dividing the plug into four surfaces. When the plug is inserted into the inserting hole, data in the interface card is transferred to the inserting seat through the four surfaces. The plug is replaceable so as to replace interface card. The inserting seat is the inserting seat of a GPA satellite signal receiver or a blue tooth device, or a digital camera.

The various objects and advantages of the present invention will be more readily understood from the following detailed description when read in conjunction with the appended drawing.

### BRIEF DESCRIPTION OF THE DRAWINGS

FIG. 1 is an exploded perspective view showing the structure of the present invention.

FIG. 2 is an assemble view of the present invention.

FIG. 3 shows one embodiment of the present invention.

FIG. 4 shows another embodiment of the present invention.

FIG. 5 shows a further embodiment of the present invention.

FIG. 6 shows the rotation of the plug of the present invention.

FIG. 7 shows the positioning of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

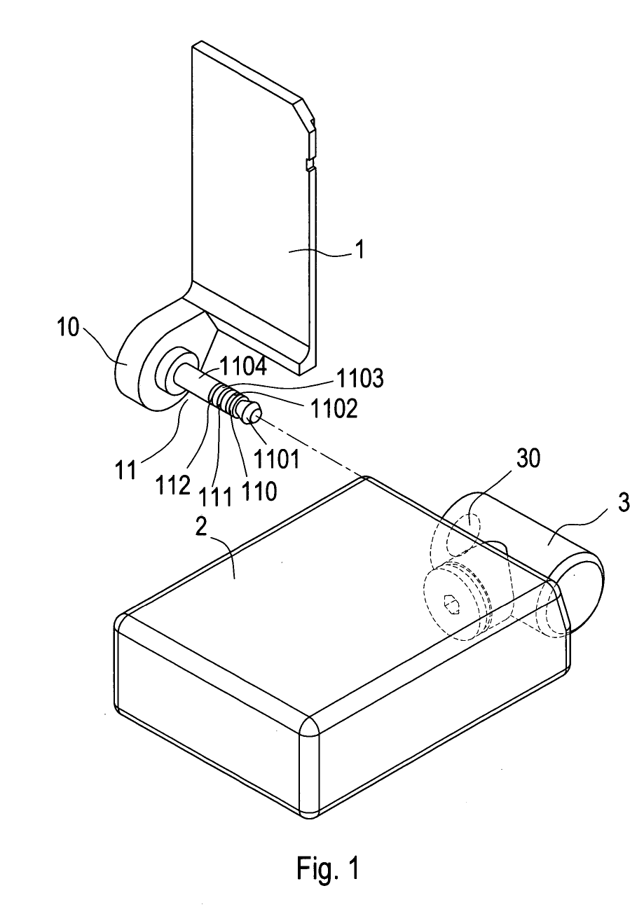

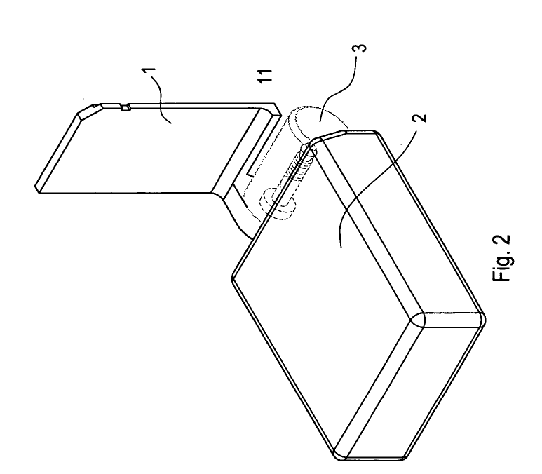

With reference to FIGS. 1 and 2, the replaceable multiple-functional interface card of the present invention is illustrated. The replaceable multiple-functional interface card of the present invention includes an interface card 1. A receptacle 10 is extended from one end of an interface card 1. A plug 11 is extended from one side of the receptacle 10. By replacing the plug 11, the interface card 1 can is replaceable so that the data to be read is replaceable. An inserting seat 2 with respect to the plug 11 has a rotary seat 3. One side of the rotary set 3 is installed with an inserting hole 30. The interface card 1 can be inserted into the inserting hole 30 of the rotary seat 3. The plug 11 is wound by three insulating wires 110, 111, and 112. The three insulating wires 110, 111, and 112 divides the plug 11 into four surfaces 1101, 1102, 1103 and 1104 which can be inserted into the inserting hole 30. Data in the interface card 1 can be transferred to the inserting seat 2 through the four surfaces 1101, 1102, 1103 and 1104.

In the present invention, the front and rear surfaces are contact surfaces for positive and negative electrodes and the middle two surfaces are used to send and receive signals.

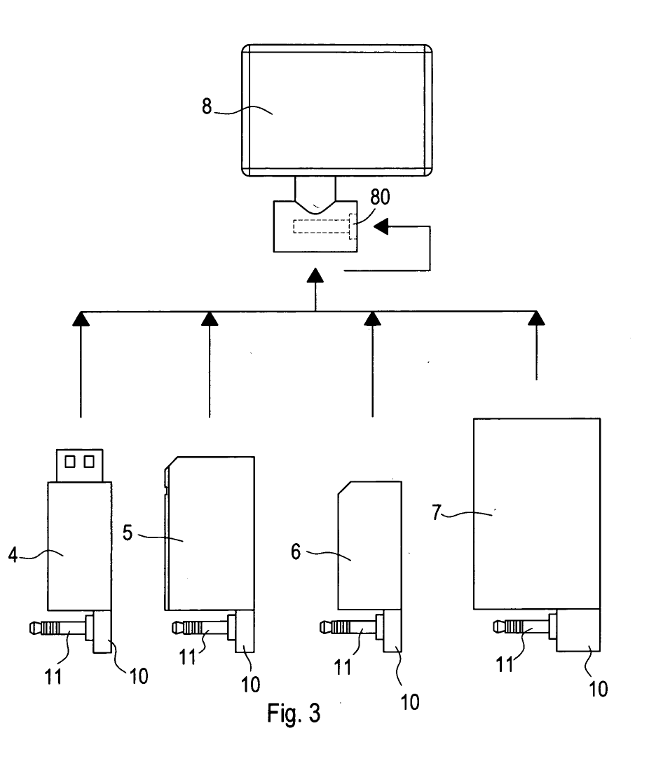

In use of the present invention, when the plug 11 of the interface card 1 is inserted into the inserting hole 30, the interface card 1 can be replaced as desired. The interface card 1 used can be selected from one of USB interface cards 4 (Universal Serial Bus interface card), SD interface cards 5 (Secure Digital interface card), MS interface cards 6 (Memory Stick interface card); CF interface cards 7 (compact flash interface cards) (see FIGS. 3, 4, and 5); MD interface cards (IBM Micro Drive interface card); SM interface cards (Smart Media interface card); MMC interface cards (Multi Media Card), etc.

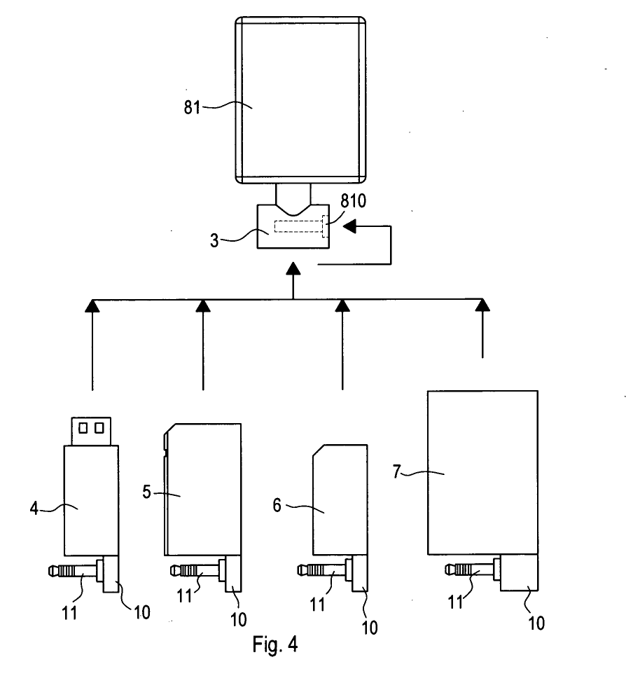

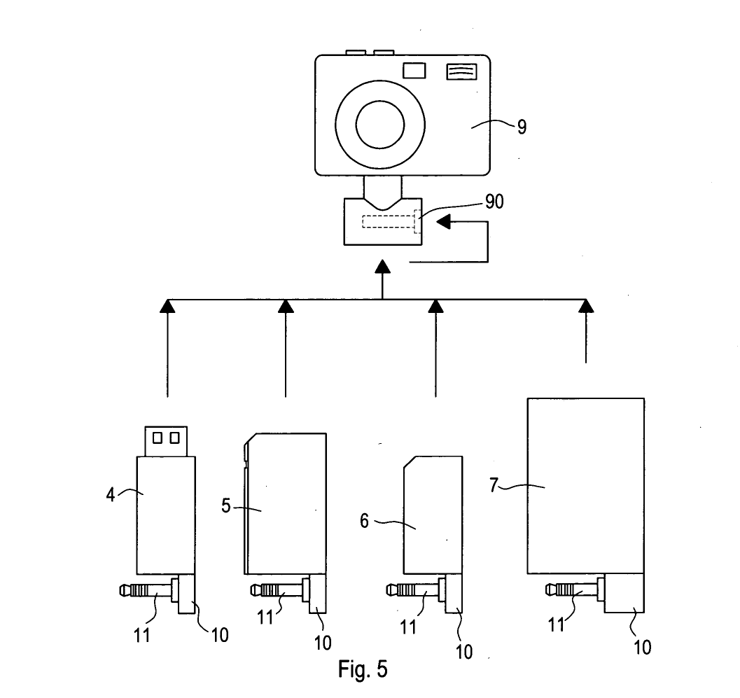

In another embodiments of the present invention, one end of a GPS satellite signal receiver seat 8 is formed with one inserting hole 80, see FIG. 3. Furthermore, in FIG. 4, it is illustrated that one end of a blue tooth receiver seat 81 is installed with an inserting hole 810. Moreover, in FIG. 5, one end of a digital camera 9 is installed with an inserting hole 90. Thereby, the plug 11 of the receptacle 10 extended from one of the USB interface cards 4 (Universal Serial Bus interface card), SD interface cards 5 (Secure Digital interface card), MS interface cards 6 (Memory Stick interface card); CF interface cards 7 (compact flash interface cards) can be inserted into the inserting holes 80, 810, or 90. By the arrangement of the present invention, the plug 11 is replaceable rapidly.

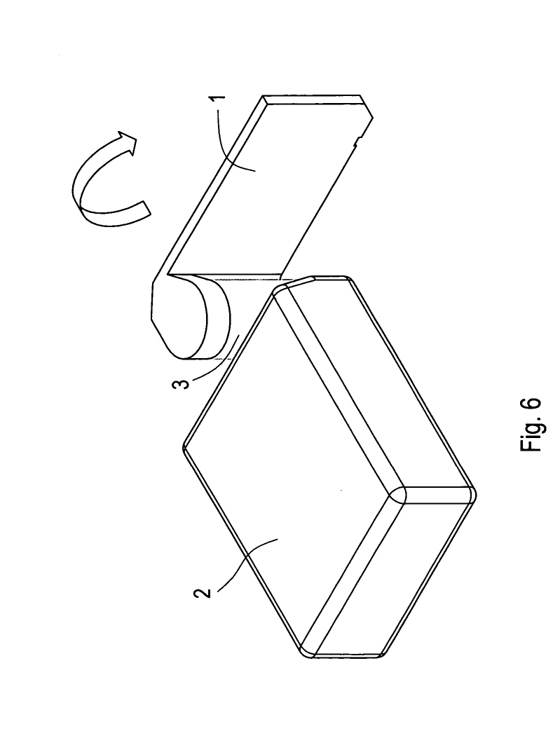

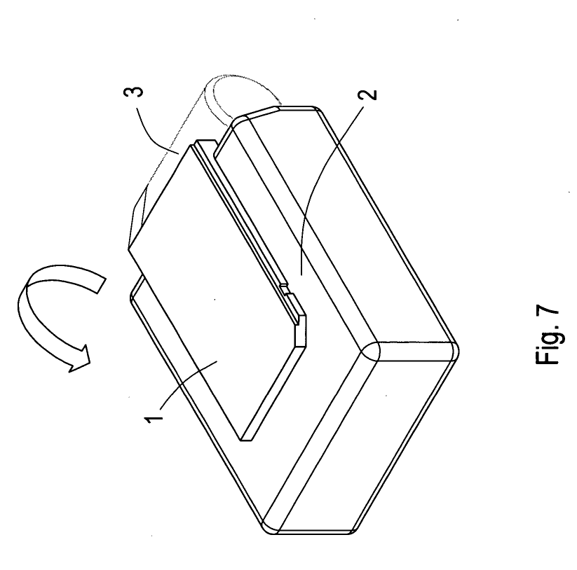

With reference to FIGS. 6 and 7, the present invention provides a replaceable multiple-functional interface card. When the plug 11 of the interface card 1 is inserted into the inserting hole 30, the interface card 1 is rotatable for adjusting the position of the interface card 1.

Advantages of the present invention will be described here. The plug is replaceable rapidly. For example, GPS satellite receiver seats, blue tooth receiver seats, digital camera receiver seats are replaceable so that data transmitted by different protocols can be transferred between the seats and the interface cards. Moreover, operation of the present invention is rapid and easily. Multiple devices (such as notebook computers, personal digital assistances etc.) can be used with multiple peripherals (such as satellite receivers, blue tooth devices, digital cameras).

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A replaceable multiple-functional interface card for inserting into an inserting seat of an electronic device; the inserting seat being extended with a rotary seat; and one side of the rotary set being installed with an inserting hole; the replaceable multiple-functional interface card comprising
an interface card;
a receptacle extended from one end of an interface card;
a plug extended from one side of the receptacle; the plug being wound by three insulating wires; the three insulating wires dividing the plug into four surfaces;
wherein when the plug is inserted into the inserting hole, data in the interface card is transferred between the inserting seat and the interface card through the four surfaces.

2. The replaceable multiple-functional interface card as claimed in claim 1, wherein the plug is replaceable so as to replace interface card.

3. The replaceable multiple-functional interface card as claimed in claim 1, wherein the inserting seat is the inserting seat of a GPS satellite signal receiver.

4. The replaceable multiple-functional interface card as claimed in claim 1, wherein the inserting seat is the inserting seat of a blue tooth device.

5. The replaceable multiple-functional interface card as claimed in claim 1, wherein the inserting seat is the inserting seat of a digital camera.

6. The replaceable multiple-functional interface card as claimed in claim 1, wherein two of the surfaces are contact surfaces for positive and negative electrodes, respectively.

7. The replaceable multiple-functional interface card as claimed in claim 1, wherein two of the surfaces are used to receive and transmit signals, respectively.
